(19) United States
(12) Patent Application Publication
(10) Pub. No.: US 2021/0322862 A1
(43) Pub. Date: Oct. 21, 2021

(54) BACCARAT METHOD OF PLAY AND PLAYING SURFACE LAYOUT

(71) Applicant: Ivan Miskovic, Sarasota, FL (US)

(72) Inventor: Ivan Miskovic, Sarasota, FL (US)

(21) Appl. No.: 16/987,706

(22) Filed: Aug. 7, 2020

(51) Int. Cl. A63F 3/00; A63F 1/06

(52) U.S. Cl. CPC A63F 3/00157; A63F 2001/001; A63F 2003/00164; A63F 1/067

(57) ABSTRACT

An improved Baccarat playing surface layout (1) and method of play wherein reserve cards are dealt prior to any wagers or hands being dealt.

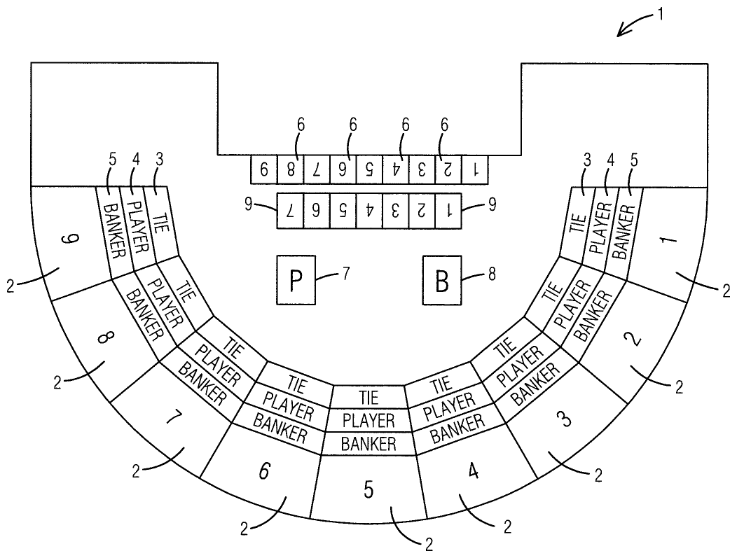

### FIELD OF THE INVENTION

This invention relates to the field of gaming and more particularly to a variant of Baccarat that provides a group of reserve cards that are held for play until after a dealer runs out of playing cards.

### BACKGROUND OF THE INVENTION

Baccarat is one of the many popular live table games played in casinos and gaming establishments. The word baccarat is derived from the Italian word “baccarat”, which means zero. The term refers to face cards and ten cards of a standard deck of playing cards, all of which have a zero value in the conventional game of baccarat.

Baccarat uses a standard deck of fifty-two cards and is usually dealt from a shoe, commonly having eight decks, that have been shuffled together and loaded into the shoe for dealing prior to the beginning of play of a round of hands. The object of Baccarat is for a player to successfully wager on whether a Banker's hand or a Player's hand will win a hand of play. Players have no discretion concerning the play of the hands, since cards are dealt according to pre-established rules. Their options prior to the dealing of a hand of Baccarat are to not bet, bet with the Banker hand, bet with the Player hand and/or to wager that the Banker hand and the Player hand will tie. The term ‘Player’ does not refer to the customer and the term ‘Banker’ does not refer to the house. They are just options on which players may bet.

In Baccarat, cards 2-9 are worth face value, 10's and face cards (J, Q, K) are worth zero points, and Aces are worth 1 point. Players calculate their score by taking the sum of all cards. The dealer deals out cards face up, two each for the player and banker. Whichever hand totals closest to nine wins. If you placed a bet on the player hand and it has the closest to nine, the winnings are simply double what you bet. If you placed a bet on the banker hand and it wins, it normally pays 95 percent of your wager. When the cards dealt are greater than nine, you are required to add the two together and drop the one or two to get the value. For example, a hand of nine and seven cards dealt would add up to 16, and with the first digit dropped, the value in the game is six.

If either the player or banker is dealt a total of eight or nine, both the player and banker stand. If the player's total is five or less, then the player will receive another card. Otherwise, the player will stand. If the player stands, then the banker hits on a total of 5 or less. The final betting option, a tie, normally pays out at 8-to-1.

A problem with conventional method of playing baccarat is a lack of the length of time it takes to turnover the eight decks of playing cards that normally make up a shoe. This is a turnoff to a player who may be experiencing a run of bad luck and who does not want to continue wagering on a bad shoe that still has multiple decks of playing cards left in it.

Conventional Baccarat also fails to provide any enticement to keep players at a table until the dealer runs out of cards and is required to reshuffle.

Therefore, a need exists for a modified method of playing Baccarat that provides a group of reserve cards to allow for the use of a smaller number of decks of playing cards and to entice players to remain at a table and keep playing and wagering until the reserve cards are shown.

### SUMMARY OF THE INVENTION

The primary object of the present invention is to provide a modified method of playing Baccarat that provides a group of reserve cards to allow for the use of a smaller number of decks of playing cards.

An additional object of the present invention is to provide a modified method of play of conventional Baccarat that entices players to continue wagering on multiple hands based on a desire play through a set of reserve cards that are dealt face down and set aside prior to play commencing.

An additional object of the present invention is to provide a modified method of play of conventional Baccarat that entices players to continue wagering on multiple hands even when experiencing bad luck based on quicker turnover and more frequent shuffling of decks of playing cards being used.

A method of playing a wagering game using at least two decks of playing cards is disclosed preferably played using an improved gaming table layout. The improved Baccarat playing surface layout provides a conventional Baccarat table layout having wagering spaces for individual players to place bets on a tie wagering space, a player wagering space, and or a banker wagering space. Optional commission boxes corresponding to each player may be provided to track player commissions owed to the house. Dealing spaces for dealing a player's hand and a banker's hand are also provided. Finally, a plurality of reserve card spaces are provided for dealing, preferably seven, reserve cards face down at the beginning of play as described below.

The game of the present invention includes the following steps.

The at least two decks of playing cards are shuffled together. Then, a plurality of reserve cards are dealt face down on the Baccarat playing surface layout. There are preferably seven reserve cards to allow for a maximum number of hands to be played using the at least two decks of playing cards.

Next, each player makes an initial wager on the playing surface to participate in a round of play. Then, two cards are dealt face up on the playing surface to a player and a banker, respectively. Next, the conventional rules of Baccarat are used to score the cards dealt to the player and the banker. Then if necessary, additional cards are dealt according to the conventional rules of Baccarat. Next, any initial wagers are resolved.

Then, subsequent hands are played until no cards are left in the at least two decks of playing cards. Next, the reserve cards are used to deal any subsequent hands.

Finally, when there are not enough reserve cards remaining to deal any additional subsequent hands, at least two decks of playing cards are shuffled together and the steps above are repeated.

The Baccarat playing surface layout of the present invention may be displayed on a table or on an electronic display, such as a smart phone, tablet, digital gaming display for a casino and so forth.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawing in which an improved Baccarat playing surface layout of the present invention is illustrated.

### DESCRIPTION OF THE PREFERRED EMBODIMENTS

For purposes of describing the preferred embodiment, the terminology used in reference to the numbered accessories in the drawings is as follows:

1. Baccarat playing surface layout, generally

2. wagering space for individual player

3. Tie wagering space

4. Player wagering space

5. Banker wagering space

6. commission box

7. dealing space for Player's hand

8. dealing space for Banker's hand

9. reserve card dealing space

With reference the attached drawing, an improved Baccarat playing surface layout 1 of the present invention is illustrated. The improved Baccarat playing surface layout 1 provides a conventional Baccarat table layout having wagering spaces 2 for individual players to place bets on a Tie wagering space 3, a Player wagering space 4, and/or a Banker wagering space 5. Optional commission boxes 6 corresponding to each player may be provided to track player commissions owed to the house. A dealing space for dealing a Player's hand 7 and a dealing space for dealing a Banker's hand 8 are provided. Finally, a plurality of reserve card dealing spaces 9 are provided for dealing, preferably seven, reserve cards at the beginning of play as described below.

The method of play includes the following steps.

At least two decks of playing cards are shuffled together. Then, a plurality of reserve cards are dealt face down on the improved Baccarat playing surface layout 1. There are preferably seven reserve cards to allow for a maximum number of hands to be played using the at least two decks of playing cards.

Next, each player makes an initial wager on the improved Baccarat playing surface layout 1 to participate in a round of play.

Then, a Player's hand and a Banker's hand are dealt face down on the improved Baccarat playing surface layout 1.

Next, the conventional rules of Baccarat are used to score the Player's hand and the Banker's hand.

Then, additional cards are dealt to the Player's hand and/or the Baker's hand if required according to the conventional rules of Baccarat.

Next, any wagers are resolved.

Then, subsequent hands are dealt and played until no cards are left in the at least two decks of playing cards.

Next, the reserve cards are used to deal any subsequent hands.

Finally, when there are not enough reserve cards remaining to deal any additional subsequent hands, the steps above are repeated using at least two decks of playing cards.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method of playing Baccarat comprising the steps of:
a) shuffling at least two decks of playing cards together;
b) dealing a plurality of reserve cards from the shuffled at least two decks of playing cards down on a playing surface facedown;
c) making at least one initial wager;
d) dealing a Player's hand and a Dealer's hand face up on the playing surface;
e) scoring the dealt Player's hand and the dealt Dealer's hand;
f) resolving any wagers;
g) performing steps c-f until no cards are left in the shuffled at least two decks of playing cards; and
h) using the plurality of reserve cards to perform steps c-f above.

2. The method of playing Baccarat of claim 1 wherein:
said plurality of reserve cards comprises seven playing cards dealt face down on the playing surface.

3. The method of playing Baccarat of claim 1 wherein:
said playing surface is a table.

4. The method of playing Baccarat of claim 1 wherein:
said playing surface is an electronic display.

5. A Baccarat playing surface layout comprising:
a plurality of wagering spaces for players to place wagers on a game of Baccarat being played on said playing surface;
said plurality of wagering spaces each having a Tie wagering space, a Player wagering space, and a Banker wagering space;
a dealing space for dealing a Player's hand and a dealing space for dealing a Banker's hand; and
a plurality of reserve card dealing spaces.

6. The Baccarat playing surface layout of claim 5 wherein:
said plurality of reserve card dealing spaces comprises seven reserve card dealing spaces.

7. The Baccarat playing surface layout of claim 5 wherein:
said Baccarat playing surface layout is displayed on a table.

8. The Baccarat playing surface layout of claim 5 wherein:
said Baccarat playing surface layout is displayed an electronic display.

9. A method of playing Baccarat on a Baccarat playing surface layout having a plurality of wagering spaces for players to place wagers on a game of Baccarat being played on said playing surface, said plurality of wagering spaces each having a Tie wagering space, a Player wagering space, and a Banker wagering space, a dealing space for dealing a Player's hand, a dealing space for dealing a Banker's hand, and a plurality of reserve card dealing spaces, said method comprising the steps of:
a) shuffling at least two decks of playing cards together;
b) dealing a plurality of reserve cards from the shuffled at least two decks of playing cards face down on said reserve card dealing spaces on said playing surface;
c) making at least one initial wager;
d) dealing a Player's hand and a Dealer's hand face up on the playing surface;
e) scoring the dealt Player's hand and the dealt Dealer's hand;
f) resolving any wagers;
g) performing steps c-f until no cards are left in the shuffled at least two decks of playing cards; and
h) using the plurality of reserve cards to perform steps c-f above.

10. The method of playing Baccarat of claim 9 wherein:
said plurality of reserve cards comprises seven playing cards dealt face down on the playing surface.

11. The method of playing Baccarat of claim 9 wherein:
said playing surface layout id displayed on a table.

12. The method of playing Baccarat of claim 9 wherein:
said playing surface layout is displayed on an electronic display.
